(19) United States
(12) Patent Application Publication
(10) Pub. No.: US 2009/0272096 A1
(43) Pub. Date: Nov. 5, 2009

(54) Single Manifold Dual Gas Turbine Fuel System

(75) Inventors: William J. Lawson, Niskayuna, NY (US); Rahul Mohan Joshi, Orlando, FL (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 12/114,893

(22) Filed: May 5, 2008

(51) Int. Cl. F02C 3/20

(52) U.S. Cl. 60/39.463

(57) ABSTRACT

The present application provides a dual gas fuel delivery system and a method of delivering two gas fuels to a turbine. The dual gas fuel delivery system may include (a) a low energy gas delivery system comprising a low energy gas inlet and a low energy gas primary manifold outlet; (b) a high energy gas delivery system comprising a high energy gas inlet and a high energy gas primary manifold outlet; and (c) a primary manifold, wherein the low energy gas primary manifold outlet and the high energy gas primary manifold outlet are coupled to the primary manifold.

### CROSS-REFERENCE TO RELATED APPLICATIONS

The present application relates to U.S. patent application Ser. No. ______ entitled “Independent Manifold Dual Gas Turbine Fuel System;” U.S. patent application Ser. No. ______ entitled “Primary Manifold Dual Gas Fuel System;” and U.S. patent application Ser. No. ______ entitled “Operation of Dual Gas Turbine Fuel System.” These applications are incorporated herein by reference.

### TECHNICAL FIELD

The present application relates to gas turbine fuel systems and more particularly relates to gas turbine fuel systems capable of delivering two or more gaseous fuels to a single manifold.

### BACKGROUND OF THE INVENTION

Modern gas turbines require precise control of the fuel system. For example, a pressure drop across the fuel nozzles must be carefully maintained within a specified range in order to avoid combustor damage. In general, it may be difficult to operate a modern gas turbine on both a normal, high energy fuel (for example, natural gas) and a high hydrogen, low energy fuel (for example, syngas). What is desired, therefore, is a “dual gas” turbine fuel system that may both accommodate and carefully control a high energy fuel, a low energy fuel, and a mix of high and low energy fuels.

### BRIEF DESCRIPTION OF THE INVENTION

The present application thus provides a dual gas fuel delivery system and a method of delivering two gas fuels.

The dual gas fuel delivery system may include (a) a low energy gas delivery system comprising a low energy gas inlet and a low energy gas primary manifold outlet; (b) a high energy gas delivery system comprising a high energy gas inlet and a high energy gas primary manifold outlet; and (c) a primary manifold, wherein the low energy gas primary manifold outlet and the high energy gas primary manifold outlet are coupled to the primary manifold.

The method of delivering fuel to a turbine may include (a) feeding a low energy gas to a low energy gas inlet of a low energy gas delivery system; (b) feeding a high energy gas to a high energy gas inlet of a high energy gas delivery system; (c) feeding the low energy gas to a primary manifold from a low energy gas primary manifold outlet of the low energy gas delivery system; (d) feeding the high energy gas to the primary manifold from a high energy gas primary manifold outlet of the high energy gas delivery system; and (e) feeding the low energy gas and the high energy gas to the turbine from the primary manifold.

These and other features of the present application will become apparent to one of ordinary skill in the art upon review of the following detailed description when taken in conjunction with the drawings and the appended claims.

### BRIEF DESCRIPTION OF THE DRAWINGS

FIG. 1 is a flow diagram that depicts a single manifold dual gas fuel delivery system.

FIG. 2 is a flow diagram that depicts a dual gas and liquid fuel delivery system.

### DETAILED DESCRIPTION OF THE INVENTION

The present application provides a dual gas fuel delivery system and a method of delivering a number of gas fuels.

I. Single Manifold Dual Gas Fuel Delivery System

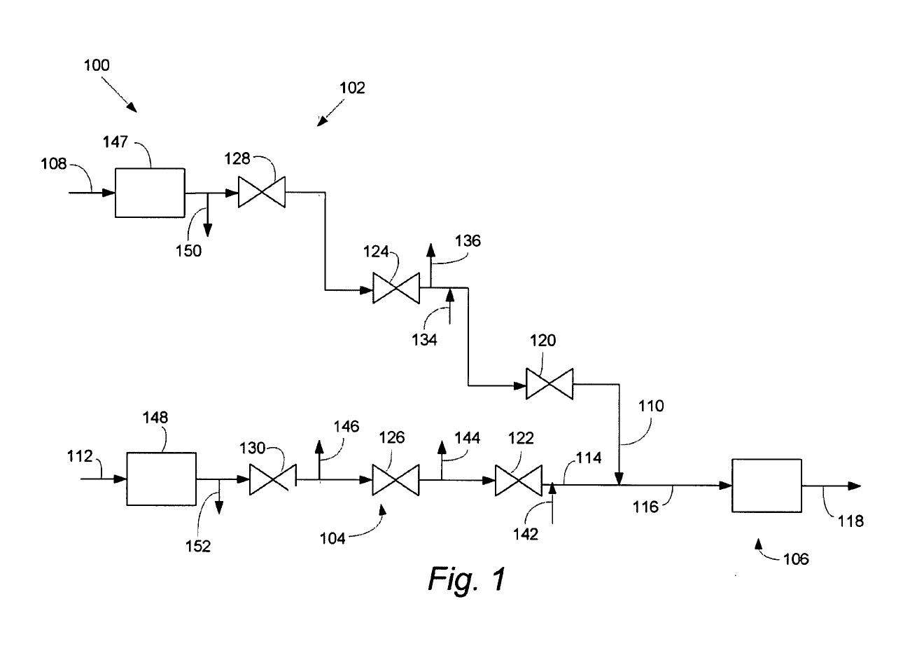

Referring now to the drawings, in which like numerals indicate like elements throughout the separate views, FIG. 1 shows a configuration of a single manifold dual gas fuel system 100. The system 100 may be used to deliver gas to a turbine. Importantly, the system 100 may deliver a high energy gas, a low energy gas, or a mixture of the high energy gas and low energy gas. The capability of the dual gas system 100 may allow the turbine to run on 100% high energy gas during start-up and shut-down. The system 100 also may allow the turbine to run under full load using either 100% low energy gas or a mixture of high energy gas and low energy gas. Because the configuration may deliver two gas fuels through a single manifold system, the fuel system 100 may be simplified. For example, the configuration may eliminate the need for fuel transfer valves and secondary gas manifolds, and reduce the complexity of a purge system.

The Gas Fuels

The system 100 may deliver a high energy gas, a low energy gas, or a mixture of high energy gas and low energy gas. The high energy gas may have an energy value in a range from about 900 to about 1100 BTU/ft³. The low energy gas may have an energy value in a range from about 820 to about 1550 BTU/ft³. In a particular embodiment, the difference in energy values between the high energy gas and the low energy gas is in a range from about 100 to about 450 BTU/ft³.

The Delivery System

The single manifold dual gas fuel system 100 may include a low energy gas delivery system 102, a high energy gas delivery system 104, and a primary manifold 106. The low energy gas delivery system 102 may include a low energy gas inlet 108 and a low energy gas primary manifold outlet 110. The high energy gas delivery system 104 may include a high energy gas inlet 112 and a high energy gas primary manifold outlet 114. The primary manifold 106 may include a primary manifold piping inlet 116 and a primary manifold nozzle outlet 118. The low energy gas primary manifold outlet 110 and the high energy gas primary manifold outlet 114 may be coupled to the primary manifold 106. For example, the low energy gas primary manifold outlet 110 and the high energy gas primary manifold outlet 114 may merge into the primary manifold piping inlet 116.

The low energy gas delivery system 102 also may include a low energy gas control valve 120 between the low energy gas inlet 108 and the low energy gas primary manifold outlet 110. Likewise, the high-energy gas delivery system 104 also may include a high energy gas control valve 122 between the high energy gas inlet 112 and the high energy gas primary manifold outlet 114. The gas control valves 120 and 122 may control the flow of fuel to the primary manifold 106 so that a precise pressure drop is maintained across the primary manifold nozzle 118.

The low energy gas delivery system 102 also may include a low energy gas stop and pressure control valve 124 between the low energy gas inlet 108 and the gas control valve 120. Likewise, the high energy gas delivery system 104 also may include a high energy gas stop and pressure control valve 126 between the high energy gas inlet 112 and the gas control valve 122. The stop and pressure control valves 124 and 126 may control the flow of fuel upstream of the gas control valves 120 and 122 so that a constant reference pressure is maintained between the stop and pressure control valves 124 and 126 and the gas control valves 120 and 122. By maintaining the areas of constant reference pressure immediately upstream of the gas control valves 120 and 122, the rate of flow through the gas control valves may be calculated using the only the positions (effective areas) of the control valves.

The low energy gas delivery system 102 also may include a low energy gas stop valve 128 between the low energy gas inlet 108 and the low energy gas stop and pressure control valve 124. Likewise, the high energy gas delivery system 104 also may include high energy gas stop valve 130 between the high energy gas inlet 112 and the high energy gas stop and pressure control valve 126. The stop valves 128 and 130 may be used to stop the flow of gas through the low energy gas delivery system 102 and the high energy gas delivery system 104, respectively. For example, if the turbine is operating on high energy gas only, the low energy gas stop valve 128 may stop the flow of gas through the low energy gas delivery system 102 so that only high energy fuel will flow through the primary manifold 106. Furthermore, if the turbine is operating on low energy gas only, the high energy gas stop valve 130 may stop the flow of gas through the high energy gas delivery system 104 so that only low energy fuel will flow through the primary manifold 106.

The low energy gas delivery system 102 also may include a low energy gas purge system between the low energy gas inlet 108 and the low energy gas control valve 120. The low energy gas purge system may include a low energy gas purge inlet 134 and a first low energy gas purge vent 136. The low energy gas purge inlet 134 may be located between the low energy gas control valve 120 and the low energy gas stop and pressure control valve 124, and the first low energy gas purge vent 136 may be located between the low energy gas control valve 120 and the low energy gas stop and pressure control valve 124. The low energy gas purge system may be used to reduce the risk of combustion when the low energy gas delivery system 102 is not in use. For example, the low energy gas purge inlet 134 and the low energy gas purge vent 136 may be used to mitigate ignition risk if the turbine trips while operating on 100% low energy fuel or a blend of low energy and high energy fuel.

The high energy gas delivery system 104 also may include a high energy gas purge system between the high energy gas inlet 112 and the high energy gas outlet 114. The high energy gas purge system may include a high energy gas purge inlet 142, a first high energy gas vent 144, and a second high energy vent 146. The high energy gas purge inlet 142 may be located between either (a) the high energy gas control valve 122 and the primary manifold nozzle outlet 118 or (b) the low energy gas control valve 120 and the primary manifold nozzle outlet 118, the first high energy gas vent 144 may be located between the high energy gas control valve 122 and the high energy gas stop and pressure control valve 126, and the second high energy gas vent 146 may be located between the high energy gas stop and pressure control valve 126 and the high energy gas stop valve 130. The gas purge system may be used to reduce the risk of combustion when the turbine trips while operating on low energy fuel or a blend of low and high energy fuels.

The low energy gas delivery system 102 also may include a low energy gas strainer 146 between the low energy gas inlet 108 and the low energy gas stop valve 128. Likewise, the high energy gas delivery system 104 also may include a high energy gas strainer 148 between the high energy gas inlet 112 and the high energy gas stop valve 130. The strainers 146 and 148 may filter debris out of the fuel in order to prevent problems such as clogging in the single manifold dual gas fuel system 100.

The low energy gas delivery system 102 also may contain a low energy gas bypass outlet 150 between the low energy gas inlet 108 and the low energy gas stop valve 128. Likewise, the high energy gas delivery system 104 also may include a high energy gas bypass outlet 152 between the high energy gas inlet 112 and the high energy has stop valve 130. The bypass outlets 150 and 152 may feed gas to systems such as a warm-up system and/or a flare system.

The single manifold dual gas fuel system 100 may be used to deliver two gas fuels to a turbine. A low energy gas may be fed to the low gas energy inlet 108 of the low energy gas delivery system 102. The low energy gas then may be fed to the primary manifold 106. For example, the low energy gas then may be fed to the primary manifold piping inlet 116 of the primary manifold 106 from the low energy gas primary manifold outlet 110 of the low energy gas delivery system 102. Likewise, a high energy gas may be fed to the high gas energy inlet 112 of the high energy gas delivery system 104. The high energy gas then may be fed to the primary manifold 106. For example, the high energy gas then may be fed to the primary manifold piping inlet 116 of the primary manifold 106 from the high energy gas primary manifold outlet 114 of the high energy gas delivery system 104. Finally, the low energy gas and the high energy gas may be fed to the turbine from the primary manifold nozzle outlet 118 of the primary manifold 106.

The method of delivering the two gas fuels to the turbine also may include passing the low energy gas through the low energy gas control valve 120 after the step of feeding the low energy gas to the low energy gas delivery system 102 and before the step of feeding the low energy gas to the primary manifold 106. Likewise, the method may include passing the high energy gas through the high energy gas control valve 122 after the step of feeding the high energy gas to the high energy gas delivery system 104 and before the step of feeding the high energy gas to the primary manifold 106.

The method of delivering the two gas fuels may further include passing the low energy gas through a low energy gas stop and pressure control valve 124 after the step of feeding the low energy gas through to the low energy gas delivery system 102 and before the step of passing the low energy gas through the low energy gas control valve 120. Likewise, the method may include passing the high energy gas through the high energy gas stop and pressure control valve 126 after the step of feeding the high energy gas to the high energy gas delivery system 104 and before the step of passing the high energy gas through the high energy gas control valve 122.

The method of delivering the two gas fuels may further include passing the low energy gas through a low energy gas stop valve 128 after the step of feeding the low energy gas through to the low energy gas delivery system 102 and before the step of passing the low energy gas through the low energy gas stop and pressure control valve 124. Likewise, the method may include passing the high energy gas through the high energy gas stop valve 130 after the step of feeding the high energy gas to the high energy gas delivery system 104 and before the step of passing the high energy gas through the high energy gas stop and pressure control valve 126.

II. Single Manifold Dual Gas and Liquid Fuel Delivery System

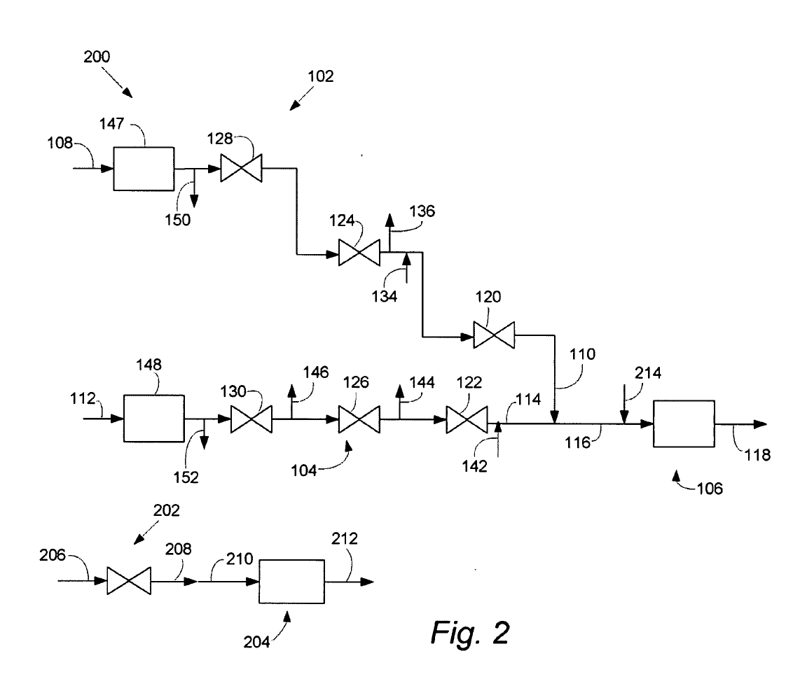

FIG. 2 shows a configuration of a dual gas and liquid fuel delivery system 200. The dual gas and liquid fuel delivery system 200 may include the low energy gas delivery system 102, the high energy gas delivery system 104, the primary manifold 106, a liquid fuel delivery system 202, and a liquid manifold 204.

The low energy gas delivery system 102 may include the low energy gas inlet 108 and the low energy gas primary manifold outlet 110. The high energy gas delivery system 102 may include the high energy gas inlet 112 and the high energy gas primary manifold outlet 114. The liquid fuel delivery system 202 may include a liquid fuel inlet 206 and a liquid fuel outlet 208. The primary manifold 106 may include the primary manifold piping inlet 116 and the primary manifold nozzle outlet 118. The liquid manifold 204 may include a liquid manifold piping inlet 210 and a liquid manifold nozzle outlet 212. The low energy gas primary manifold outlet 110 and the high energy gas primary manifold outlet 114 may be coupled to the primary manifold 106. For example, the low energy gas primary manifold outlet 110 and the high energy gas primary manifold outlet 114 may merge into the primary manifold piping inlet 116. The liquid fuel outlet 208 may be coupled to the liquid manifold 204. For example, the liquid fuel outlet 208 may merge into the liquid manifold piping inlet 210.

The primary manifold 106 also may include an air inlet 214. The air inlet 214 may supply air to the primary manifold in order to purge the primary manifold 106 of gas, maintain a positive nozzle pressure ratio in the primary manifold 106, and/or keep the primary manifold nozzle outlet 118 cool.

The dual gas and liquid fuel delivery system 200 may be used to deliver two gas fuels and a liquid fuel to a turbine. A low energy gas may be fed to the low gas energy inlet 108 of the low energy gas delivery system 102. The low energy gas then may be fed to the primary manifold piping inlet 116 of the primary manifold 106 from the low energy gas primary manifold outlet 110 of the low energy gas delivery system 102. Likewise, a high energy gas may be fed to the high gas energy inlet 112 of the high energy gas delivery system 104. The high energy gas then may be fed to the primary manifold piping inlet 116 of the primary manifold 106 from the high energy gas primary manifold outlet 114 of the high energy gas delivery system 104. A liquid fuel may be fed to the liquid fuel inlet 206 of the liquid fuel delivery system 202. The liquid fuel then may be fed to the liquid manifold piping inlet 210 of the liquid manifold 204 from the liquid fuel outlet 208 of the liquid fuel delivery system 202. Finally, the low energy gas and the high energy gas may be fed to the turbine from the primary manifold nozzle outlet 118 of the primary manifold 106, and the liquid fuel may be fed to the turbine from the liquid manifold nozzle outlet 212 of the liquid manifold 204.

It should be understood that the foregoing relates only to the preferred embodiments of the present application and that numerous changes and modifications may be made herein without departing from the general spirit and scope of the invention as defined by the following claims and the equivalents thereof.

We claim:

1. A fuel delivery system, comprising:
a) a low energy gas delivery system comprising a low energy gas inlet and a low energy gas primary manifold outlet;
b) a high energy gas delivery system comprising a high energy gas inlet and a high energy gas primary manifold outlet; and
c) a primary manifold,
wherein the low energy gas primary manifold outlet and the high energy gas primary manifold outlet are coupled to the primary manifold.

2. The system of claim 1, wherein:
the low energy gas delivery system further comprises a low energy gas control valve between the low energy gas inlet and the low energy gas primary manifold outlet; and
the high energy gas delivery system further comprises a high energy gas control valve between the high energy gas inlet and the high energy gas primary manifold outlet.

3. The system of claim 2, wherein:
the low energy gas delivery system further comprises a low energy gas stop and pressure control valve between the low energy gas inlet and the low energy gas control valve; and
the high energy gas delivery system further comprises a high energy gas stop and pressure control valve between the high energy gas inlet and the high energy gas control valve.

4. The system of claim 3, wherein:
the low energy gas delivery system further comprises a low energy gas stop valve between the low energy gas inlet and the low energy gas stop and pressure control valve; and
the high energy gas delivery system further comprises a high energy gas stop valve between the high energy gas inlet and the high energy gas stop and pressure control valve.

5. The system of claim 4, wherein:
the low energy gas delivery system further comprises a low energy gas purge system between the low energy gas stop valve and the low energy gas control valve; and
the high energy gas delivery system further comprises a high energy gas purge system between the high energy gas stop valve and the high energy gas control valve.

6. The system of claim 5, wherein:
the low energy gas purge system comprises a low energy gas purge inlet and a low energy gas purge vent; and
the high energy gas purge system comprises a high energy gas purge inlet and a high energy gas purge vent.

7. The system of claim 1, further comprising:
d) a liquid fuel delivery system comprising a liquid fuel inlet and a liquid fuel outlet; and
e) a liquid manifold,
wherein the liquid fuel outlet is coupled to the liquid manifold.

8. The system of claim 7, wherein:
the primary manifold further comprises an air inlet.

9. A method of delivering fuel to a turbine, comprising:
a) feeding a low energy gas to a low energy gas inlet of a low energy gas delivery system;
b) feeding a high energy gas to a high energy gas inlet of a high energy gas delivery system;
c) feeding the low energy gas to a primary manifold from a low energy gas primary manifold outlet of the low energy gas delivery system;
d) feeding the high energy gas to the primary manifold from a high energy gas primary manifold outlet of the high energy gas delivery system; and
e) feeding the low energy gas and the high energy gas to a turbine from the primary manifold.

10. The method of claim 9, further comprising:
passing the low energy gas through a low energy gas control valve after the step of feeding the low energy gas to the low energy gas delivery system and before the step of feeding the low energy gas to the primary manifold; and
passing the high energy gas through a high energy gas control valve after the step of feeding the high energy gas to the high energy gas delivery system and before the step of feeding the high energy gas to the primary manifold.

11. The method of claim 10, further comprising:
passing the low energy gas through a low energy gas stop and pressure control valve after the step of feeding the low energy gas to the low energy gas delivery system and before the step of passing the low energy gas through the low energy gas control valve; and
passing the high energy gas through a high energy gas stop and pressure control valve after the step of feeding the high energy gas to the high energy gas delivery system and before the step of passing the high energy gas through the high energy gas control valve.

12. The method of claim 11, further comprising:
passing the low energy gas through a low energy gas stop valve after the step of feeding the low energy gas to the low energy gas delivery system and before the step of passing the low energy gas through the low energy gas stop and pressure control valve; and
passing the high energy gas through a high energy gas stop valve after the step of feeding the high energy gas to the high energy gas delivery system and before the step of passing the high energy gas through the high energy gas stop and pressure control valve.

13. The method of claim 9, further comprising:
f) feeding a liquid fuel to a liquid fuel inlet of a liquid fuel delivery system;
g) feeding the liquid fuel to a liquid manifold from a liquid fuel outlet of the liquid fuel delivery system; and
h) feeding the liquid fuel to the turbine from the liquid manifold.
